(19) United States
(12) Patent Application Publication
(10) Pub. No.: US 2004/0100940 A1
(43) Pub. Date: May 27, 2004

(54) Enhanced PDP context management using radio parameter information elements added to messages

(75) Inventors: Pekka Juhani Kuure, Espoo (FI); Jari Vallstrom, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/307,198

(22) Filed: Nov. 27, 2002

(51) Int. Cl. H04J 3/24

(52) U.S. Cl. 370/349

(57) ABSTRACT

A method is described for operating a mobile station with a wireless network having packet data capabilities, as is a network that operates in accordance with the method. The method includes establishing default operational parameters values for the mobile station and, when establishing a PDP Context for use by an application, such as a delay-critical application that may be a real-time application (or any application that requires specific operational values, such as DRX values), requesting a modification of the default operational parameters values so as to reduce the delay in the establishment of a TBF for the application. In the preferred embodiment the operational parameters comprise DRX parameters selected to optimize the paging operation of the MS to reduce the delay in transferring packet data to or from the MS. In other embodiments the operational parameters can include MS Radio Access Capability (RAC) parameters, such as Multi-slot Class, GPRS Timers and/or MS Power Class. In one embodiment, requesting a modification includes sending a PDP Context-related message from the mobile station to the network with an information element that specifies values for parameters of the DRX mode, where the values comprise a Split_PG_Cycle code and a non-DRX timer. In this case the PDP Context-related messages comprise one of an Activate PDP Context request, an Activate Secondary PDP Context request and a Modify PDP Context request. The method further includes, when terminating the PDP Context, requesting a modification of the paging parameters values so as to have the default or other parameters values. Preferably, when terminating the PDP Context the mobile station sends a Deactivate PDP Context request message with the information element that specifies the default values for the parameters of the DRX mode.

### TECHNICAL FIELD

This invention relates generally to wireless communications systems and methods and, more specifically, to cellular communications systems and methods that provide packet-based data services between a wireless network and a mobile station (MS), such as a wireless packet data terminal. Even more specifically, this invention is related to General Packet Radio Service (GPRS) signaling and, more specifically still, to the negotiation of Discontinuous Reception (DRX) parameters for Packet Data Protocol (PDP) context establishment.

### BACKGROUND

At present, the GPRS is used only for non-real time data services. However, it is expected that the continued evolution of wireless packet-based services will require that GPRS be applied as well to real-time data services. For example, real-time data services are expected to be enabled with the implementation of the Third Generation Partnership Project (3G-PP) Release 1999 (R'99) specifications, which specify support for Streaming and Conversational traffic classes between a wireless network and a MS, via a Base Station System (BSS).

In order to place the ensuing discussion into a technological context, reference is made to FIG. 1 for showing a simplified block diagram of a wireless communications system 1. The system 1 includes a number of hardware and software units associated with a network operator 2, also referred to herein as network infrastructure, and at least one MS 10. The MS 10 includes an antenna 10A for conducting bidirectional RF communications with an antenna 20A of a BSS 20. The BSS 20 includes a Base Station Controller/Packet Control Unit (BSC/PCU) 22 and at least one, but typically a number of Base Transceiver Stations (BTS) 24. The BSC/PCU 22 is bidirectionally coupled to a Serving GPRS Support Node (SGSN) 30, that in turn is bidirectionally coupled to a Gateway GPRS Support Node (GGSN) 40. The GGSN 40 is bidirectionally coupled to a Packet Data Network (PDN) 50, such as the internet. The typical circuit switched equipment for enabling conventional voice calls is not shown in order to simplify the drawing.

During the development of one useful new service, referred may be referred to for convenience as Push to talk over Cellular (PoC) or simply Push to Talk (PTT), the inventors have observed that the GPRS lower layer functionality is currently not optimal for implementing real-time services. As such, a need has arisen to enhance the GPRS implementation so as to fluently support co-existing applications with different bearer requirements.

In the Global System for Mobile Communications (GSM) Specification 03.13 the DRX function is defined as follows:

“DRX is a technique that allows the mobile station to power down significant amounts of its internal circuitry for a high percentage of the time when it is in the idle mode.

It also ensures that the MS is aware of exactly when page requests for it may be transmitted and it can then therefore schedule other tasks such that it avoids the problem of not decoding valid page requests transmitted by the network in the idle mode periods.

The technique works by dividing the MSs within a cell into a set of groups. The group in which an MS resides is then known locally at both the MS and the BSS. All paging requests to each group are then scheduled and sent at a particular time, which is derived from the TDMA frame number in conjunction with the IMSI of the MS and some BCCH transmitted data.

Thus both the BSS and the MS know when relevant page requests will be sent and the MS can power down for the period when it knows that page requests will not occur.”

The PTT type of service is considered to be a real-time service, and therefore imposes more strict requirements on the GPRS bearers than traditional non-real time services. One of the requirements of the PTT service is that the MS 10 must be ready to accept a down link (DL) transmission as quickly as possible in order to minimize the delays perceived by the users. One way to reduce the delay in accepting the down link transmission is to minimize the duration of the paging period, and to increase the non-DRX time.

FIG. 2 shows an example of a plurality of paging periods (about 2.2 second in duration) in relation to a point in time where incoming data arrives at the SGSN 30 for the MS 10. There is then some random amount of time (zero to about 2.2 seconds) before the generated page is received by the MS 10. After the page is received there is some delay for DL Temporary Block Flow (TBF) establishment and before speech (assuming a real-time Voice over IP (VoIP) application is running) is actually received at the MS 10. The TBF is essentially a logical channel between the network and the MS 10 through which data flows. In future enhancements to GPRS more than one TBF may simultaneously exist in each direction (UL and/or DL) for providing data to one or more applications executing in the MS 10. At present, however, there can exist only one TBF per direction at a time. If multiple MS applications are running, then the TBF can be shared between them where possible (e.g., same Radio Link Control (RLC) mode, same Access Point Name (APN), similar Quality of Service (QoS) for each of the applications). If the common TBF cannot be shared, then the TBF for one application is released and another one is activated when switching from application to another.

When the paging period is reduced it is implied that the MS 10 can be paged more frequently, and thus the delay in establishing the DL TBF, via the paging procedure, is minimized.

Referring also to FIG. 3, when in a non-DRX mode the MS 10 monitors each paging block (i.e., not only those paging blocks specified according to a negotiated paging cycle), and thus the DL TBF can be established rapidly, as the BSS 20 need not wait for the paging group of the MS 10 to occur before transmitting the page to the MS 10. When the non-DRX time is long, it is also implied that within a PTT interactive session the MS 10 may be more rapidly reached during the typical short inactive periods between talkspurts. Also, it is typically the case for interactive sessions that the party who is the speaker changes quickly, meaning that when user-A has stopped talking then user-B quickly replies.

An additional benefit of having a long non-DRX time (and conversely a short MS 10 sleep period), especially during a PTT group communication, is that all group members begin to receive the DL talk burst within a narrower time window. As a consequence, the talk spurts also end within a narrow time window between different users. If a paging procedure is used then there will be a delay distribution window from zero to about two seconds (depending on the nature of the sleep cycle) before all DL users have received paging requests. This can result in an undesirable situation, where different group members experience the start and end of the talk spurt at different times, and react accordingly. For the case of a group conversation this can result in the occurrence of objectionable synchronization problems between the various participants.

One benefit that is derived by the cellular system infrastructure 2, with faster DL TBF establishment, is that the SGSN 30 is not required to buffer as many data packets received from the PDN 50 via the GGSN 40. This is an important consideration, especially with real-time packet traffic, since by definition a faster response is required for real-time applications. In addition, the required data buffering capacity in the SGSN 30 is relaxed when the DL TBF establishment occurs more rapidly.

However, a significant disadvantage of using a short paging period, and a long non-DRX time as in the lower trace shown in FIG. 3, is that the MS 10 consumes more battery power.

A sleep time (Split_PG_Cycle) code and a non-DRX timer are two DRX parameters that form a part of a DRX parameters Information Element (IE), as can be found in 3GPP Specification 24.008, in Paragraph 10.5.5.6 “DRX Parameter”, where the value part of the DRX parameter information element is coded as shown in Table 10.5.139 of the same Specification. These parameters, negotiated with the MS 10, are stored by the SGSN 30 in a memory 30A. As an example, if the value of the Split_PG_Cycle parameter is seven, then the MS 10 will exit the sleep mode (the low power consumption state) to receive a page message approximately every 2.2 seconds. As another example, if the value of the Split_PG_Cycle is 64, then the MS 10 will be ready to receive a paging message every 240 ms. The correlation between the Split_PG_Cycle code and the paging sub-channel is defined such that the MS 10 listens to the paging sub-channel in every 64/Split_PG_Cycle multi-frame, where the multi-frame duration is 240 ms.

The DRX parameters IE can be found in and may be used by, according to current specifications, a GPRS Attach Request message and a Routing Area Update request (RAU) message. In accordance with current practice, however, at least some providers of the infrastructure 2 do not support DRX parameter negotiation during the RAU procedure. Thus, in practice, the current GPRS implementations can be guaranteed to support the negotiation of the DRX parameters, e.g., Split_PG_Cycle Code and non-DRX time, only during the GPRS Attach procedure (i.e., only with the use of the GPRS Attach Request message).

In accordance with conventional practice, during the GPRS Attach procedure the MS 10 connects to the GPRS network 2. The purpose of the GPRS Attach procedure is to permit authentication of the MS 10, to permit ciphering to be implemented, to allocate a temporary identity (TLLI) to the MS 10, and to copy the subscriber's profile from the Home Location Register (HLR) to the SGSN 30. During the GPRS Attach procedure the DRX parameters are agreed to. As the network 2 then knows what paging blocks will be received by the MS 10, the network 2 can then send paging messages to the MS 10. These paging messages can be related to, for example, Short Message Service (SMS), a circuit switched call, or any command from the network 2. However, after having completed the GPRS Attach procedure the MS 10 is not able to transmit or receive packet data, since it does not yet have an assigned IP address, and the other parameters required for the data transfer have not yet been negotiated, such as PDP type (IP or X.25), the Quality of Service (QoS), or the Access Point Name (APN).

In order to be capable of transferring packet data, a PDP Context Activation procedure must first occur. The MS 10 makes a PDP Context Request, and the network 2 responds with the necessary information for enabling the MS 10 to transfer packet data. In general, the MS 10 obtains an IP address from the network 2 to enable the data transfer (MS 10, SGSN 30, GGSN 40). In addition, routing information is set up so that the GGSN 40 knows where to route incoming (DL) packets, A given MS 10 may have several PDP contexts. The parameters that are negotiated during the PDP Context Activation procedure include, for example, the QoS, the IP address, the PDP type and the APN (e.g., wap.operator.com or internet.operator.com). Applications with similar attributes can share a PDP Context. As an example, e-mail and WAP applications may use the same PDP Context having the same QoS, APN and PDP type. If the MS 10 has an active PDP Context, and if a new application requires, for example, a different QoS or APN, then a new PDP Context needs to be activated.

As a result of a PDP Context being activated for the MS 10, the SGSN 30 has a logical bi-directional tunnel between the MS 10 and one GGSN 40, the GGSN 40 has a PDP address activated and the location of the MS 10 is known to within the accuracy of the BSC/PCU (Routing Area), and the MS 10 can then transfer data using its assigned PDP address.

Assume as an example that the MS 10 activates an e-mail service procedure. In this case an Activate PDP Context request message is sent on the UL to the SGSN 30 via the BSS 20. Subsequently an Activate PDP Context Accept message is received on the DL at the MS 10 from the SGSN 30, and the MS subscriber is then allowed to use e-mail. If there is incoming e-mail from the PDN 50, the network 2 pages the MS 10. To perform this procedure the SGSN 30 determines the location of the MS 10 to within the accuracy of the Routing Area. That is, the SGSN 30 knows the identity of the BSC/PCU 22, but not the BTS 24, and paging messages are broadcast on all of the BTSs 24 in the Routing Area. The SGSN 30 checks the DRX parameters of the MS 10 based on the stored values, and may further transfer the stored DRX parameters values to the BSC/PCU 22 in, as examples, the Paging PS, Paging CS and DL-Unitdata messages. The paging delay is uniformly distributed between zero and about 2.2 seconds (i.e, has an average delay of about 1.1 seconds). For the case of e-mail (anon-real time application), the time of the actual reception of the page within the 2.2 second window is normally not critical. However, for the case of a real-time application such as VoIP, the variable page-related delay of up to 2.2 seconds can be very objectionable.

Whether the DRX parameters are negotiated in the Attach or the RAU procedure, the DRX parameters are valid for all Packet Data Protocol (PDP) contexts. When the MS 10 supports the PTT functionality then it would be preferable that the DRX parameters be configured so as to best support this application. However, other applications that also use GPRS are then required to use the same DRX parameters, and it is not possible to then optimize energy saving features when only non-real time applications are in use.

Said another way, when the DRX parameters are negotiated during the Attach procedure, then the negotiated parameters are valid for all subsequent PDP contexts. If the negotiated DRX parameters are optimized for a non-real time application, then the PTT or any other real-time services will be at a disadvantage due to the longer delays that are incurred in DL TBF establishment. On the other hand, if the negotiated DRX parameters are optimized for PTT, or for some other real-time service, then the power consumption of the MS 10 can be excessive when executing non-real time applications.

At first glance it might appear that the MS 10 could, every time there is an activation or a deactivation of a real-time service, perform an Attach or a Detach procedure with the network 2. However, this is not a practical solution as it requires additional signalling between the MS 10 and the network 2, thereby consuming signalling bandwidth, and furthermore the user may have other ongoing PDP contexts that would also need to be deactivated during the detach procedure.

It is also noted that the current specifications allow DRX parameters negotiation during the RAU (Routing Area Update) procedure. In this case, as another possibility, the MS 10 could perform the RAU procedure every time there is an activation or deactivation of a real-time service. However, and as was noted above, it is not assured that all infrastructure providers will support DRX parameter negotiation during the RAU procedure, thereby making this approach unworkable. Further, it is generally not desirable to use a procedure, such as the RAU procedure, for a purpose other than its intended purpose. In addition, the use of the RAU procedure strictly for DRX parameters negotiation would be wasteful of signalling bandwidth.

To summarize, in accordance with conventional practice the DRX parameters are negotiated during the GPRS Attach procedure. Since it is impossible for the MS 10 to accurately predict beforehand what type(s) of service will be required of it during a session, the resulting DRX parameters are at best a compromise between the real-time/non-real time service needs of the MS 10, and possibly not optimized for either, or optimized for one type of service to the detriment of the other type of service.

### SUMMARY OF THE PREFERRED EMBODIMENTS

The foregoing and other problems are overcome, and other advantages are realized, in accordance with the presently preferred embodiments of these teachings.

A method is disclosed for operating a mobile station with a wireless network having packet data capabilities, as is a network that operates in accordance with the method. The method includes establishing default operational parameters values for the mobile station and, when establishing a PDP Context for use by an application, such as a delay-critical application that may be a real-time application (or any application that requires specific operational values, such as DRX values), requesting a modification of the default operational parameters values so as to reduce the delay in the establishment of a TBF for the application. In the preferred embodiment the operational parameters comprise DRX parameters selected to optimize the paging operation of the MS to reduce the delay in transferring packet data to or from the MS. In other embodiments the operational parameters can include MS Radio Access Capability (RAC) parameters, such as Multi-slot Class, GPRS Timers and/or MS Power Class.

In one embodiment, requesting a modification includes sending a PDP Context-related message from the mobile station to the network with an information element that specifies values for parameters of the DRX mode, where the values comprise a Split_PG_Cycle code and a non-DRX timer. In this case the PDP Context-related messages comprise one of an Activate PDP Context request, an Activate Secondary PDP Context request and a Modify PDP Context request. The method further includes, when terminating the PDP Context, requesting a modification of the paging parameters values so as to have the default parameters values. Preferably, when terminating the PDP Context the mobile station sends a Deactivate PDP Context request message with the information element that specifies the default (or other) values for the parameters of the DRX mode. The method can further include acknowledging that the requested modification is agreed to by one of implicitly acknowledging (e.g., simply by acceptance of the values) or explicitly acknowledging (e.g., by including the values in an acceptance message) that the requested modification is agreed to. Further in this regard the method can further include acknowledging that the requested modification is agreed to by the network by including the agreed values of the DRX parameters in one of an Activate PDP Context Accept message, an Activate Secondary PDP Context Accept message and a Modify PDP Context Accept message that is sent to the mobile station, or for the deactivation case by including the default values of the DRX parameters in a Deactivate PDP Context Accept message that is sent to the mobile station.

Further in this regard, the method may further include acknowledging that values requested by the MS are not agreed to by the network by sending one of an Activate PDP Context Accept, an Activate Secondary PDP Context Accept and a Modify PDP Context Accept message that include a DRX parameters IE with values other than those requested by the MS. For the deactivation case, this can be accomplished by including other values than those requested by the MS in a DRX parameters IE that is included in the Deactivate PDP Context Accept message.

In another embodiment requesting a modification includes sending a PDP Context-related message from the network to the mobile station with the information element that specifies values for the parameters of the DRX mode. In this case the PDP Context-related message comprises a Request PDP Context Activation message. Acknowledging that the requested modification is agreed to by the mobile station can be done by including the agreed to DRX parameters in an Activate PDP Context Request message that is sent to the network. It also with thin the scope of these teachings to not acknowledge that the requested modification is agreed to by the mobile station by including the default or other values of the DRX parameters in the Activate PDP Context Request message that is sent to the network.

The step of establishing can include transmitting a GPRS Attach Request message from the mobile station to the network, the GPRS Attach Request message containing values of the default parameters.

As was noted above, the method is not limited to use with DRX parameters values, but can also be applied, by example, to requesting a modification of the default value of the mobile station Radio Access Capabilities Information Element, e.g., Multi-slot Class and/or the GPRS Timers.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 illustrates a simplified block diagram of a conventional wireless communications system;

FIG. 2 shows a plurality of conventional paging periods in relation to an arrival of a data packet at the SGSN shown in FIG. 1;

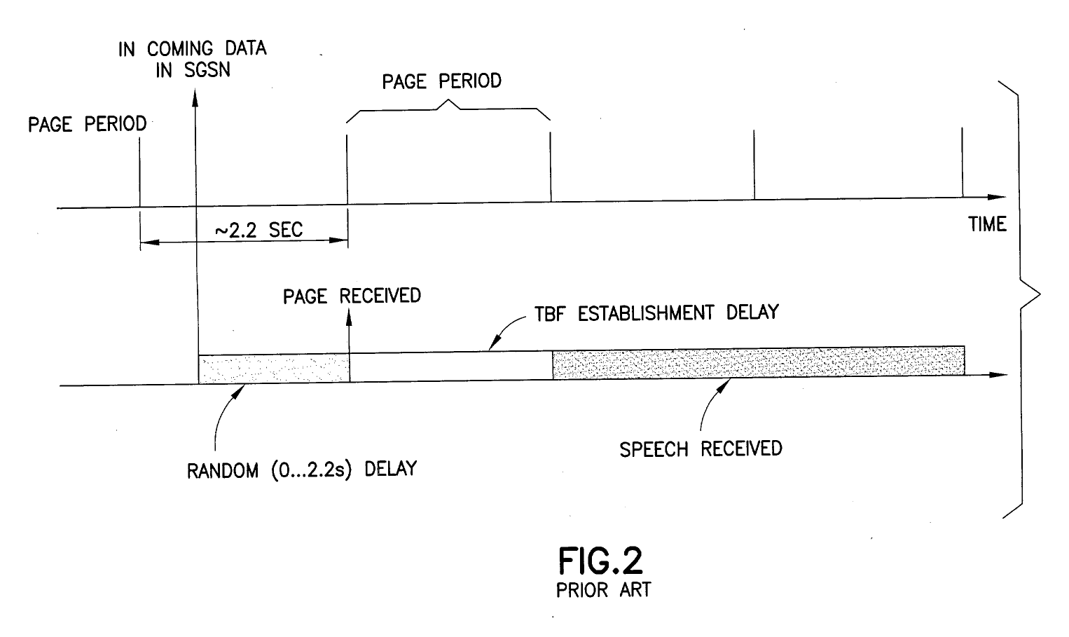

FIG. 3 shows examples of TBF establishment for the case of short and long non-DRX times; and

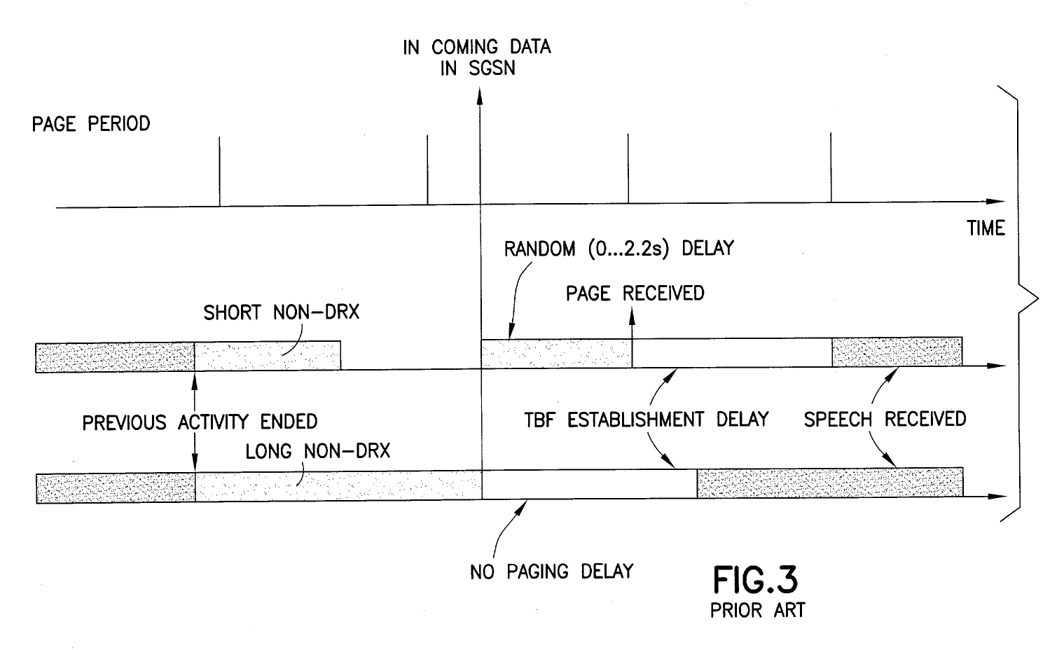

FIGS. 4 and 5 are logic flow diagrams that are useful in explaining the operation of the preferred embodiments of this invention.

### DETAILED DESCRIPTION OF THE PREFERRED EMBODIMENTS

This invention provides a technique for the DRX parameters to be negotiated so as to best support the actual service needs of an application (e.g., to provide a short DL TBF establishment time for real-time applications, and reduced power consumption for non-real time applications).

Reference can be made to 3GPP TS 24.008 V5.4.0 (2002-06), Chapter 6, “Support for packet services”, pps. 191-207, and Chapter 9, “Message functional definitions and contents”, pps. 213-289, as at least these portions of the document describe the conventional management of GPRS packet services. The GPRS Session Management Messages found in Chapter 9.5 (pps. 279-289) are of most interest to the teachings of this invention. In general, this invention provides techniques to enhance the management of the conventional GPRS packet services. Reference can also be made to Chapter 10, “General message format and information elements coding”, pps. 290-429, where, for example, the conventional DRX information element description can be found (Chapter 10.5.5.6).

This invention introduces an optional Information Element field in a plurality of GPRS PDP context negotiation messages. The Information Element field includes Radio Parameters, such as DRX parameter values. In a presently preferred, but non-limiting embodiment the DRX Information Element field can be included in several UL GPRS PDP context negotiation messages: Activate PDP Context request, Activate Secondary PDP Context request, Modify PDP Context request and Deactivate PDP Context request. It is also within the scope of this invention to modify a plurality of DL Accept messages to include a DRX parameters IE to confirm changes to the DRX parameters, e.g., Activate PDP Context Accept, Activate Secondary PDP Context Accept, Modify PDP Context Accept and Deactivate PDP Context Accept. Network 2 originated PDP Context Activations can also benefit by the teachings of this invention, as will be described in further detail below.

In accordance with an aspect of this invention, when only non-real time service PDP contexts are activated, default DRX parameters that have been previously negotiated in the conventional GPRS Attach, and stored by the SGSN 30, are used. When a real-time service is activated, such as the PTT service, the DRX parameters that are deemed to be optimal for the real-time service are included in the DRX Information Element field of an Activate PDP Context request message. When the PTT (or other real-time application) session terminates, and there are no other real-time applications active, then the default (e.g., non-real time) DRX parameters may be included in the DRX Information Element field of a Deactivate PDP Context request message.

In general, this invention can be applied with advantage for use with delay-critical applications, which can include real-time applications or substantially real-time applications, and for use with any application having specific requirements for the DRX and/or other parameters values so as to optimize or enhance the operation of the application.

In some cases the PDP context may be utilized by more than one application. If the PDP context is used by both real-time and non-real time applications, then the DRX parameters may be negotiated with the Modify PDP Context request procedure. From the point of view of the packet data network 2, the SGSN 30 uses the last-negotiated DRX parameters, i.e., those DRX parameters that have been last negotiated override the previously negotiated DRX parameters.

By the use of this invention it becomes possible to achieve a balance between an optimal user service experience and service time. For example, when there is an active real-time application all active PDP contexts (real-time and non-real time) benefit from the more rapid establishment of the DL TBF, and when the real-time application is deactivated the DRX parameters are renegotiated to values (e.g., to default values) that are more optimal from an energy conservation perspective.

The following non-limiting examples explain the usage of the enhanced DRX IE signalling in greater detail.

### EXAMPLE A

MS 10 is not GPRS Attached to the network 2, and a non-real time application is required

For this example it can be assumed that initially the GPRS network 2 has no knowledge of the MS 10. Assume now further that the user selects a non-real time application “e-mail”, such as from a displayed menu on a screen of the MS 10. In response, the MS 10 GPRS attaches to the GPRS network 2 and, as a result, the GPRS network 2 has knowledge of the existence of the MS 10, its location, its paging group, and so forth. Assume also that the default DRX parameter values (e.g., 2.2 second sleep time and a one second non-DRX time) are used in the GPRS Attach message. However, at this point data cannot be transferred as the MS 10 must first activate a PDP Context for the e-mail application. Thus, the MS 10 transmits an Activate PDP Context Request message to the network 2, and after successful activation of the PDP Context the e-mail data can be transferred (to or from the MS 10).

### EXAMPLE B

MS 10 is not GPRS Attached to the network 2, and a real-time application is required

Option 1:

For this example assume again that initially the GPRS network 2 has no knowledge of the MS 10. Assume now further that the user selects a real-time application such as push-to-talk (PTT). In response, the MS 10 GPRS attaches to the GPRS network 2 and uses the default DRX parameter values (e.g., 2.2 second sleep time and a one second non-DRX time). The MS 10 subsequently transmits an Activate PDP Context Request message to the network 2 with new values in the DRX parameters IE, i.e., values that will optimize the MS/network interaction for the PTT application. After successful activation of the PDP Context the data/speech transfer occurs using the optimized DRX parameters. When the PTT application is terminated, the associated PDP Context can be deactivated by one of: (a) sending the network 2 a Deactivate PDP Context message with a DRX parameters IE that contains the default (or some other) values; or (b) sending the network 2 a Modify PDP Context message with a DRX parameters IE that contains the default (or some other) values, if another application is still active and requires the PDP Context.

Option 2:

Assume again that initially the GPRS network 2 has no knowledge of the MS 10 and that the user selects a real-time application such as PTT. In response, the MS 10 GPRS attaches to the GPRS network 2 using the optimal DRX parameter values for the PTT application. The MS 10 subsequently transmits an Activate PDP Context Request message to the network 2, but without the optional DRX parameters IE, as the optimal DRX parameters values have already been stored by the SGSN 30. After successful activation of the PDP Context the data/speech transfer occurs using the optimized DRX parameters. When the PTT application is terminated, and as was the case for Option 1, the associated PDP Context can be deactivated by one of: (a) sending the network 2 a Deactivate PDP Context message with a DRX parameters IE that contains the default (or some other) values; or (b) sending the network 2 a Modify PDP Context message with a DRX parameters IE that contains the default (or some other) values, if another application is still active and requires the PDP Context.

### EXAMPLE C

MS 10 is already GPRS Attached to the network 2, and a non-real time application is required

For this example assume that the MS 10 is already GPRS Attached to the network 2 (with default DRX parameters values), and thus the network 2 has knowledge of the location (Routing Area and BSC/PCU 22) and the paging group of the MS 10. Assume also that the user selects the non-real time e-mail application. In response, the MS 10 transmits an Activate PDP Context Request message to the network 2. Since the default DRX parameters values (e.g., 2.2 second sleep time and a one second non-DRX time) may be assumed to be suitable for the selected non-real time application, the optional DRX parameters IE can be left out of the Activate PDP Context Request message. After successful activation of the PDP Context, the e-mail data can be transferred (to or from the MS 10).

### EXAMPLE D

MS 10 is already GPRS Attached to the network 2, and a real-time application is required

For this example assume that the MS 10 is already GPRS Attached to the network 2 (with default DRX parameters values), and thus the network 2 has knowledge of the location (Routing Area and BSC/PCU 22) and the paging group of the MS 10. Assume also that the user selects the real-time PTT application. Since no suitable PDP Context is currently in existence, the MS 10 transmits an Activate PDP Context Request message to the network 2 with new values in the DRX parameters IE, i.e., values that will optimize the MS/network interaction for the PTT application. After successful activation of the PDP Context the data/speech transfer occurs using the optimized DRX parameters. When the PTT application is terminated, the associated PDP Context can be deactivated by one of: (a) sending the network 2 a Deactivate PDP Context message with a DRX parameters IE that contains the default (or some other) values; or (b) sending the network 2 a Modify PDP Context message with a DRX parameters IE that contains the default (or some other) values, if another application is still active and requires the PDP Context.

### EXAMPLE E

MS 10 is already GPRS Attached to the network 2, a PDP Context exists but cannot be used

For this example assume that the MS 10 is already GPRS Attached to the network 2 (with default DRX parameters values), and that a PDP Context already exists. Assume also that the user selects the real-time PTT application. For this example it is assumed that the PDP Context is not appropriate for the real-time PTT application (e.g., the active PDP Context is for another APN (internet.operator.com versus ptt.operator.com). Since no suitable PDP Context is currently in existence, the MS 10 transmits an Activate PDP Context Request message to the network 2 with new values in the DRX parameters IE, i.e., values that will optimize the MS/network interaction for the PTT application. After successful activation of the PDP Context the data/speech transfer occurs using the optimized DRX parameters. When the PTT application is terminated, the associated PDP Context can be deactivated by one of: (a) sending the network 2 a Deactivate PDP Context message with a DRX parameters IE that contains the default (or some other) values; or (b) sending the network 2 a Modify PDP Context message with a DRX parameters IE that contains the default (or some other) values, if another application is still active and requires the PDP Context.

### EXAMPLE F

MS 10 is already GPRS Attached to the network 2, a PDP Context exists and it can be used

Assume that the MS 10 is already GPRS Attached to the network 2, that a PDP Context already exists and that the user selects the real-time PTT application (or any other real-time application). For this example it is assumed that PDP Context is suitable for the PTT application, but that the DRX parameters are not optimal (e.g., they are the default parameters). The MS 10 transmits a Modify PDP Context Request message to the network 2 with new, optimized values for the DRX parameters IE, i.e., values that will optimize the MS/network interaction for the PTT application. When the Modify PDP Context Request message is accepted the MS 10 and the SGSN 30 store the new DRX parameters values and the data/speech transfer occurs using the optimized DRX parameters. When the PTT application is terminated, the associated PDP Context can be deactivated by one of: (a) sending the network 2 a Deactivate PDP Context message with a DRX parameters IE that contains the default (or some other) values; or (b) sending the network 2 a Modify PDP Context message with a DRX parameters IE that contains the default (or some other) values, if another application is still active and requires the PDP Context.

### EXAMPLE G

MS 10 is already GPRS Attached to the network 2, and the application requires two PDP Contexts (a Primary and a Secondary PDP Context)

For this example assume that the MS 10 is already GPRS Attached to the network 2 (with valid default DRX parameters values). Assume also that the user selects the real-time PTT application but that it requires two PDP Contexts. The MS 10 performs the first (Primary) PDP Context activation for a first part of the application that does not require a high QoS, and with delays that can be tolerated by the default DRX parameters values. For example, the first part of the application is a Session Initiation Protocol (SIP). The first or Primary PDP Context Activation message in this case does not require that the optional DRX parameters values be included. The MS 10 then sends the Secondary PDP Context Activate Request for the Real Time Protocol (RTP) with the optimized DRX parameters values IE included as part of the Secondary PDP Context Activate Request message. After successful activation of the Secondary PDP Context the data/speech transfer occurs using the optimized DRX parameters. The default DRX parameters values can then be subsequently restored by the MS 10 transmitting a Deactivate Secondary PDP Context message to the network 2, with the default DRX parameters values included in the DRX parameters values IE.

### EXAMPLE H

### MS 10 is already GPRS Attached to the network 2, and the application requires two PDP Contexts (two Primary PDP Contexts)

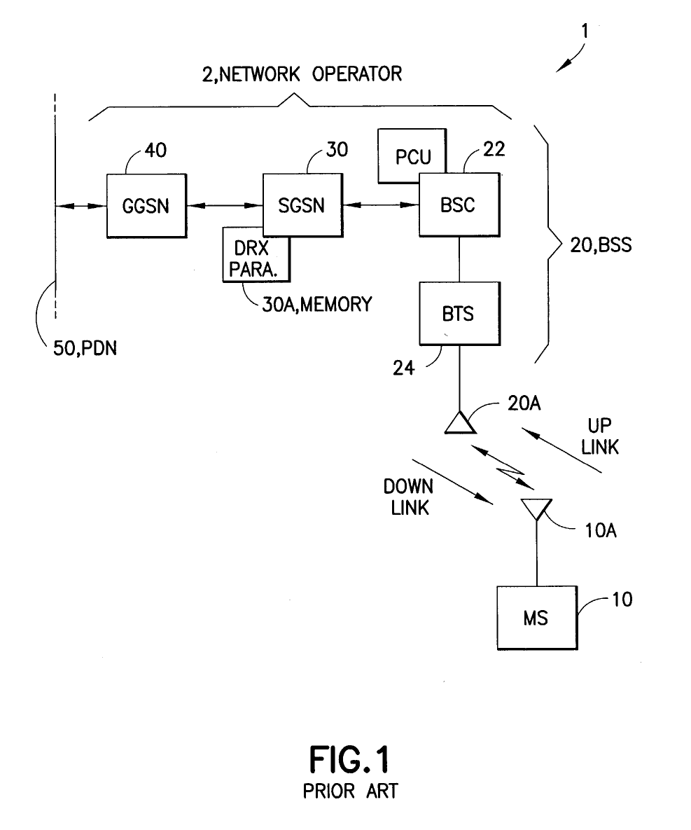

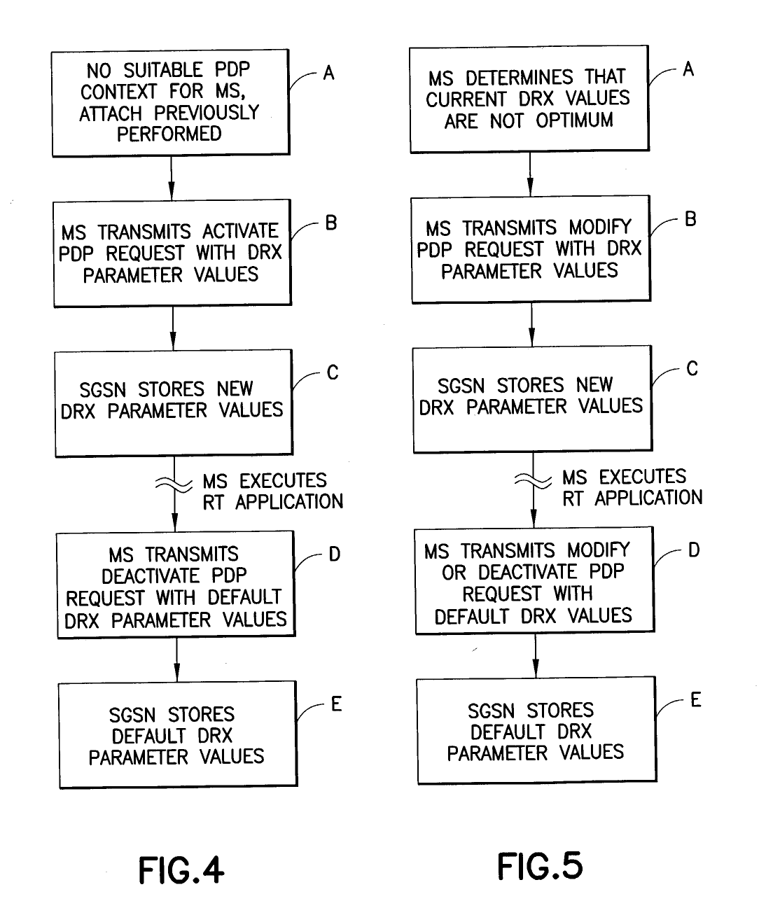

Assume that the MS 10 is already GPRS Attached to the network 2 (with default DRX parameters values). Assume also that the user selects the real-time PTT application but that it requires two PDP Contexts. The MS 10 performs the first (Primary) PDP Context activation for a first, non-real time part of the application, e.g., SIP, by sending an Activate PDP Context Request message with the DRX parameters values IE included. The DRX parameters values are assumed to be optimal for the real-time part of the application. The MS 10 then sends a second Activate PDP Context Request message for the Real Time Protocol (RTP) without the optimized DRX parameters values IE included, as they were previously sent and established within the activation of the first (Primary) PDP Context. Alternatively, the MS 10 performs the first (Primary) PDP Context activation for the first, non-real time part of the application, e.g., the SIP, by sending the Activate PDP Context Request message without the DRX parameters values IE included (thereby maintaining the default DRX parameters values in effect). The MS 10 then sends the second Activate PDP Context Request message for the RTP with the optimized DRX parameters values IE included. After successful activation of the second (Primary) PDP Context the data/speech transfer occurs using the optimized DRX parameters. The default DRX parameters values can then be subsequently restored by the MS 10 transmitting a Deactivate PDP Context Request message to the network 2, with the default DRX parameters values included in the DRX parameters values IE, or by sending a Modify PDP Context Activation message when the real-time application terminates, if another application is still active and requires the PDP Context. To illustrate certain of these cases, reference is made to FIGS. 4 and 5, which show the operation of the system 1 of FIG. 1 when modified in accordance with the teachings of this invention.

In FIG. 4 the Block A assumes that there is no useful PDP Context activated in the MS 10, and therefore a new PDP Context has to be activated to support more stringent Quality of Service (QoS) requirements of a real-time application. Block A further assumes that the MS 10 has been previously GPRS Attached, and during the ATTACH procedure the MS 10 negotiated the default DRX parameters with the SGSN 30. These include, for example, a paging cycle corresponding to about 2.2. seconds, i.e., the value of the Split_PG_Cycle parameter was specified as seven, which is not, however, useful for a real-time service that requires a prompt response.

At Block B the MS 10 sends an Activate PDP Context Request message with an appropriate DRX Parameters IE included in the request message. At Block C the SGSN 30 writes the new DRX parameter values into memory 30A and deletes the previous values. The MS 10 and the network 2 then use the new DRX parameters values that are optimal for real-time services.

When the user un-subscribes from the real-time service, it triggers deactivation of the PDP Context that is currently in effect. In order to obtain the benefit of reduced power consumption, and hence to increase battery life, the default DRX parameter values should be restored so as to increase the DRX (sleep) time of the MS 10. To achieve this goal, at Block D the MS 10 sends a Deactivate PDP Context request message with a selected DRX parameters IE attached to the deactivation message. This DRX parameters IE includes the default values (assuming that the default is the non-real time service) for the MS 10. At Block E the SGSN 30 writes the new (default) values into memory 30A and overwrites the previous values that were established for use during the real-time application.

Referring to FIG. 5, in this case the user intends to subscribe to a real-time service (e.g., VOIP), and there exists a PDP Context that could be otherwise useful, but the DRX 10 parameters are not appropriate for real-time service (Block A). In this case it is assumed that the real-time application may use the existing PDP Context, but the DRX parameters values should be modified.

At Block B the MS 10 sends a Modify PDP Context request message to the network 2, including the DRX parameters IE with DRX values deemed to be better suited for the real-time application. When receiving the Modify PDP Context request message the SGSN 30 writes the new DRX values into memory 30A, overwriting the previous values (Block C). The MS 10 and the network 2 then use the newly negotiated DRX values. When the user decides to un-subscribe from the real-time service that required different DRX parameters for optimal operation, the default values are preferably restored. The default values are restored at Block D by the MS 10 sending a Modify PDP Context request message with the default DRX parameters as the DRX parameters IE, or with the Deactivate PDP Context request message, assuming that the PDP Context is no longer required, and at Block E where the SGSN 30 writes the new (default) values into memory 30A and overwrites the previous values that were established for use during the real-time application.

In addition to including the DRX Parameters IE within the PDP Context-related messages, e.g., within the Activate PDP Context request, Modify PDP Context request and Deactivate PDP Context request messages, in further embodiments of this invention it may be desirable to include other IEs that it may be beneficial to re-negotiate when the MS 10 transitions between real-time and non-real time applications. For example, one additional IE of interest is the MS Radio Access Capabilities IE, which includes at least a MS 10 Multi-slot Class field. This IE may also be included in the PDP Context-related messages, since for some real-time applications it may be desirable to downgrade the multi-slot abilities of the MS 10, e.g., due to increased demands placed on the MS 10 data processor when executing some real-time applications. In another non-limiting example the GPRS Timers IE can be included, as for certain applications it may prove useful to negotiate the GPRS Timers, e.g. the READY timer.

To summarize the foregoing description of the preferred embodiments of this invention, initially the MS 10 may not be attached to the GPRS network 2, or it may be attached, and has negotiated default DRX parameters values, but has no PDP Context and thus is unable to transfer data. Alternatively, the MS 10 may be GPRS Attached, and may have a PDP Context that cannot be used, since at least one of the negotiated attributes are unsuited for an intended new application. Alternatively, the MS 10 may be GPRS Attached, and may have a PDP Context that can be used by modifying the DRX parameters values IE (by sending a Modify PDP Context Request with a DRX parameters values IE that modifies the existing DRX parameters values. Alternatively, the MS 10 may be GPRS Attached, and may have a PDP Context that can be used as is, as the DRX parameters values are already optimized for a real-time application. Alternatively, the MS 10 may be GPRS Attached, and may have a (primary) PDP Context to a suitable APN. In this case an Activate PDP Context Request can be sent with a real-time optimized DRX parameters values IE. Alternatively, the MS 10 may be GPRS Attached, and may have a (primary) PDP Context to a suitable APN, and suitable DRX parameters values. In this case an Activate Secondary PDP Context Request may be sent, but without the (optional) DRX parameters values IE.

According to the current 3GPP Specification the MS 10 must send the DRX parameters values IE in the GPRS Attach message. Normally the DRX parameters values are the default values, but not necessarily, as it is known that the GPRS Attach message can include DRX parameters values that are optimized for real-time. This can occur, by example, even if the MS 10 is not GPRS Attached, when the user selects a real-time application from the menu of the MS 10. It is assumed that, at any moment, both the MS 10 and the SGSN 30 have knowledge of the last-negotiated DRX parameters values. The restoration of the default (original) DRX values can be accomplished with a Deactivate PDP Context Request message by including the DRX parameters values IE with the default values of the Split_PG_Cycle and non-DRX timer parameters. Typically the restoration of the default values occurs when terminating the real-time service. The restoration of the default DRX values can also be accomplished with a Modify PDP Context Request message by including the DRX parameters values IE with the default values of the Split_PG_Cycle and non-DRX timer parameters. In this case the restoration of the default DRX parameters values can occur when terminating the real-time service, and when another application, such as a non-real time application, is still using the PDP Context and does not require the more stringent DRX operation. The restoration of the default values may also occur when terminating the real-time service when the MS 10 has both a Primary and a Secondary PDP Context associated with an application, In this case deactivation of the Primary (or Secondary) PDP Context can include sending the optional DRX parameters values IE to restore the default DRX parameters values, assuming that the Secondary (or Primary) PDP Context can operate with the default DRX values.

In addition to the management of the DRX parameters values as summarized above, the same management techniques can be employed to revise other parameters, such as default values for the MS Radio Access Capability (RAC) Information Element (including, for example, the MS Power Class). Establishing the PDP Context in this case may request a modification of at least one default value of the MS RAC, such as the GPRS Timers and the MS 10 Multi-slot Class, by adding either the entire MS RAC IE, or selected fields of same, to messages related to PDP Contexts (Activation, Deactivation and Modification).

In any of the foregoing cases the network infrastructure 2 can confirm the requested changes by adding the most-recently negotiated and accepted DRX parameters values (as well as the GPRS Timers and Multi-slot Class values if used) to an Activate PDP Context Accept, Activate Secondary PDP Context Accept, Modify PDP Context Accept and Deactivate PDP Context Accept message sent on the DL to the MS 10. If not expressly acknowledged, the default MS 10 operation may be to assume acceptance. Alternatively, if not expressly acknowledged the MS 10 may assume that the proposed changes were not accepted, as might occur in the case where the network 2 does not support the use of the optional DRX parameters values IE.

Further in this regard, the method may include indicating that values requested by the MS 10 are not agreed to by network 2 by sending one of an Activate PDP Context Accept, an Activate Secondary PDP Context Accept and an Modify PDP Context Accept message and including a DRX parameters IE having values other than those requested by the MS 10, or for the PDP Context deactivation case, by including other values that those requested by the MS 10 in the DRX parameters IE included in the Deactivate PDP Context Accept message.

While described thus far in the context of MS 10 originated PDP Context-related parameter modification, it is also within the scope of this invention to provide for network 2 originated PDP Context-related parameter modification. For example, the network can also initiate PDP Context activation by sending a Request PDP Context Activation message (see 3GPP TS 24.008 V5.4.0 (2002-06), chapter 6.1.3.3.1.). The network 2 initiated case is implemented by adding the DRX parameters IE to the Request PDP Context Activation message sent by the network 2 to the MS 10. Upon receipt of the message the MS 10 can confirm the newly proposed values by accepting the initiation and sending the Activate PDP Context Request message with the DRX parameters IE included, where the parameters values are those proposed by the network 2. The MS 10 can accept the network 2 initiated PDP Context, but not the new parameters values, by replying with the Activate PDP Context Request message containing a DRX parameter IE with values other than those proposed by network 2, e.g., the MS 10 can reply with the default DRX values, or with other DRX parameters values. Alternatively, if not expressly acknowledged, the network 2 may assume that the proposed changes were not accepted by MS 10, as might occur in the case that the MS 10 does not support the use of the optional DRX parameters IE in PDP Context-related messages. The MS 10 may also retain the current DRX parameters values by rejecting the network 2 initiated PDP Context by sending a Request PDP Context Activation Reject message to the network 2. It should be noted that the MS 10 preferably keeps the DRX parameters values unchanged in the event that the network 2 does not expressly acknowledge receiving the PDP Context-related message from the MS 10.

It should be further noted that the MS 10 may reject network 2 requested DRX parameters values by sending a PDP Context Accept message that includes a DRX parameters information element with values other than those requested by the network.

While described in the context of certain presently preferred embodiments, this invention should not be construed as being limited to only these embodiments. For example, other real-time applications that can benefit for the application of these teachings include, but are not limited to, multi-participant gaming applications and multi-participant musical applications, such as MIDI-based or MIDI-related musical applications.

In a further embodiment of this invention the SGSN 30 may not over-write or erase the previously stored MS 10 default DRX parameter values, but may maintain them and then automatically re-activate them upon receiving a conventional Deactivate PDP Context request message from the MS 10 that terminates a PDP Context established for a real-time application (assuming that this was the only real-time application of the MS 10 that was in effect). In this case the sending of the conventional Deactivate PDP Context request message by the MS 10, without including the DRX parameters IE, and the receipt of same by the SGSN 30, is assumed to be a de facto request to re-establish the previously established default DRX parameters. In this manner some amount of signalling bandwidth is conserved, but at the expense of a possible decrease in reliability due to the elimination of an affirmative signalling/acknowledgment protocol.

In a further embodiment the default PDP Context DRX parameters of the MS 10 maybe ones established for optimizing the execution of a real-time application or applications, and the MS 10 then sends the DRX Parameters IE within a PDP Context-related message so as to modify the DRX parameters to be more suitable for use in a non-real-time application that is to be executed (e.g., an e-mail application). At the termination of the e-mail application the MS 10 and SGSN 30 cooperate to restore the default, real-time DRX parameters values.

Thus, it can be appreciated that those skilled in the art may derive a number of modifications to this invention, when guided by the foregoing description, and that all such modifications will still fall within the scope of this invention.

What is claimed is:

1. A method for operating a mobile station with a wireless network having packet data capabilities, comprising:
establishing default paging parameters values for the mobile station; and
when establishing a packet data protocol PDP Context for use by an application, requesting a modification of the default paging parameters values so as to optimize the paging operation for the application.

2. A method as in claim 1, where requesting a modification includes sending a PDP Context-related message from the mobile station to the network with an information element that specifies values for parameters of a discontinuous reception (DRX) mode.

3. A method as in claim 2, where the values comprise a Split_PG_Cycle code and a non-DRX timer.

4. A method as in claim 1, where requesting a modification includes sending a PDP Context-related message from the network to the mobile station with an information element that specifies values for parameters of a discontinuous reception (DRX) mode.

5. A method as in claim 4, where the values comprise a Split_PG_Cycle code and a non-DRX timer.

6. A method as in claim 2, where the PDP Context-related messages comprises one of an Activate PDP Context request, an Activate Secondary PDP Context request and a Modify PDP Context request.

7. A method as in claim 1, further comprising when terminating the PDP Context, requesting a modification of the paging parameters values so as to have the default parameters values.

8. A method as in claim 7, where when terminating the PDP Context the mobile station sends a Deactivate PDP Context request message with the information element that specifies the default values for the parameters of the DRX mode.

9. A method as in claim 4, where the PDP Context-related message comprises a Request PDP Context Activation message.

10. A method as in claim 1, further comprising acknowledging that the requested modification is agreed to by one of implicitly acknowledging or explicitly acknowledging that the requested modification is agreed to.

11 A method as in claim 2, further comprising acknowledging that the requested modification is agreed to by the network by including the agreed values of the DRX parameters in one of an Activate PDP Context Accept message, an Activate Secondary PDP Context Accept message and a Modify PDP Context Accept message that is sent to the mobile station.

12 A method as in claim 8, further comprising acknowledging that the requested modification is agreed to by the network by including the default values of the DRX parameters in a Deactivate PDP Context Accept message that is sent to the mobile station.

13. A method as in claim 4, further comprising acknowledging that the requested modification is agreed to by the mobile station by including the agreed to DRX parameters in an Activate PDP Context Request message that is sent to the network.

14. A method as in claim 4, further comprising not acknowledging that the requested modification is agreed to by the mobile station by including the default or other values of the DRX parameters in an Activate PDP Context Request message that is sent to the network, or by sending a PDP Context Accept message that includes a DRX parameters information element with values other than those requested by the network.

15. A method as in claim 4, where said network keeps the DRX parameters values unchanged in the event the mobile station does not expressly acknowledge receiving the PDP Context-related message from the network.

16. A method as in claim 2, further comprising indicating that values requested by the mobile station are not agreed to by the network by sending one of an Activate PDP Context Accept, an Activate Secondary PDP Context Accept and an Modify PDP Context Accept message that includes a DRX parameters information element with values other than those requested by the mobile station.

17. A method as in claim 16, where for the case of a PDP Context deactivation, indicating that values requested by the mobile station are not agreed to by the network by sending a Deactivate PDP Context Accept message that includes a DRX parameters information element with values other than those requested by the mobile station.

18. A method as in claim 2, where said mobile station keeps the DRX parameters values unchanged in the event the network does not expressly acknowledge receiving the PDP Context-related message from the mobile station.

19. A method as in claim 1, where the application comprises a delay-critical application.

20. A method as in claim 1, where establishing comprises transmitting a GPRS Attach Request message from the mobile station to the network, the GPRS Attach Request message comprising default parameters values.

21. A method as in claim 1, further comprising establishing default values for a mobile station Radio Access Capability RAC Information Element, and where establishing the PDP Context requests a modification of at least one default value of the MS RAC.

22. A method as in claim 1, further comprising establishing a default value for at least one of a mobile station Multi-slot Class and General Packet Radio System GPRS Timers, and where establishing the PDP Context requests a modification of the default value of at least one of the Multi-slot Class and the GPRS Timers.

23. A communications system comprising at least one mobile station and a wireless network infrastructure having packet data capabilities, said system further comprising circuitry for establishing default paging parameters values for the mobile station and circuitry, responsive to establishing a packet data protocol PDP Context for use by an application, for requesting a modification of the default paging parameters values so as to optimize the paging operation for the application.

24 A communications system as in claim 23, where said circuitry, when requesting the modification, sends a PDP Context-related message from the mobile station to the network with an information element that specifies values for parameters of a discontinuous reception (DRX) mode.

25. A communications system as in claim 24, where the values comprise a Split_PG_Cycle code and a non-DRX timer.

26. A communications system as in claim 23, where said circuitry, when requesting the modification, sends a PDP Context-related message from the network to the mobile station with an information element that specifies values for parameters of a discontinuous reception (DRX) mode.

27. A communications system as in claim 26, where the values comprise a Split_PG_Cycle code and a non-DRX timer.

28. A communications system as in claim 24, where the PDP Context-related messages comprises one of an Activate PDP Context request, an Activate Secondary PDP Context request and a Modify PDP Context request.

29. A communications system as in claim 23, where said circuitry is further responsive to terminating the PDP Context for requesting a modification of the paging parameters values so as to have the default parameters values.

30. A communications system as in claim 29, where when terminating the PDP Context mobile station circuitry sends a Deactivate PDP Context request message with the information element that specifies the default values for the parameters of the DRX mode.

31. A communications system as in claim 26, where the PDP Context-related message comprises a Request PDP Context Activation message.

32. A communications system as in claim 23, further comprising circuitry operable for acknowledging that the requested modification is agreed to by one of implicitly acknowledging or explicitly acknowledging that the requested modification is agreed to.

33. A communications system as in claim 24, further comprising circuitry for acknowledging that the requested modification is agreed to by the network by including the agreed values of the DRX parameters in one of an Activate PDP Context Accept message, an Activate Secondary,PDP Context Accept message and a Modify PDP Context Accept message that is sent to the mobile station.

34. A communications system as in claim 30, further comprising circuitry for acknowledging that the requested modification is agreed to by the network by including the default values of the DRX parameters in a Deactivate PDP Context Accept message that is sent to the mobile station.

35. A communications system as in claim 26, further comprising circuitry for acknowledging that the requested modification is agreed to by the mobile station by including the agreed to DRX parameters in an Activate PDP Context Request message that is sent to the network.

36. A communications system as in claim 26, further comprising circuitry for not acknowledging that the requested modification is agreed to by the mobile station by including the default or other values of the DRX parameters in an,Activate PDP Context Request message that is sent to the network.

37. A communications system as in claim 23, where the application comprises a delay-critical application.

38. A communications system as in claim 23, further comprising circuitry for transmitting a GPRS Attach Request message from the mobile station to the network, the GPRS Attach Request message comprising values of the default parameters.

39. A communications system as in claim 23, further comprising circuitry for establishing default values for a mobile station Radio Access Capability RAC Information Element, and where establishing the PDP Context requests a modification of at least one default value of the MS RAC.

40. A communications system as in claim 23, further comprising circuitry for establishing a default value for at least one of a mobile station Multi-slot Class and General Packet Radio System GPRS Timers, and where establishing the PDP Context requests a modification of the default value of at least one of the Multi-slot Class and the GPRS Timers.

41. A method for operating a mobile station with a wireless network having packet data capabilities, comprising:
establishing default operational parameters values for the mobile station; and
when establishing a packet data protocol PDP Context for use by an application, requesting a modification of the default operational parameters values so as to at least reduce the delay in the establishment of a Temporary Block Flow TBF for the application.

42. A method as in claim 41, where the operational parameters comprise Discontinuous Reception DRX parameters selected to optimize the paging operation of the mobile station.

43. A method as in claim 41, where the operational parameters further comprise mobile station Radio Access Capability RAC parameters.

44. A method for operating a mobile station with a wireless network having packet data capabilities, comprising:
establishing default Discontinuous Reception DRX parameters values for the mobile station; and
when establishing a packet data protocol PDP Context for use by a time-critical application, requesting a modification of the default DRX parameters values so as to reduce the delay in transferring packet data to or from the mobile station.
